(19) United States
(12) Patent Application Publication
(10) Pub. No.: US 2025/0033513 A1
(43) Pub. Date: Jan. 30, 2025

(54) TELEMATICS CARBON EMISSION TRACKER TOOL AND METHOD

(71) Applicant: State Farm Mutual Automobile Insurance Company, Bloomington, IL (US)

(72) Inventor: Daniel Wilson, Glendale, AZ (US)

(21) Appl. No.: 18/763,986

(22) Filed: Jul. 3, 2024

Related U.S. Application Data
(60) Provisional application No. 63/515,756, filed on Jul. 26, 2023.
(60) Provisional application No. 63/609,678, filed on Dec. 13, 2023.

(51) Int. Cl. B60L 53/66; B60L 53/30

(52) U.S. Cl. CPC B60L 53/66; B60L 53/305

(57) ABSTRACT

A telematics computing system including at least one memory, and at least one processor is disclosed. The at least one processor is configured to receive information corresponding to a charging station where an electric vehicle is charged, receive greenhouse emissions information corresponding to a unit of electricity provided by the charging station for charging the electric vehicle, determine a total number of units of electricity outputted for charging the electric vehicle, determine a number of units of electricity stored in the battery consumed for operating the electric vehicle, determine an amount of greenhouse emissions by the electric vehicle for a predetermined criterion, determine a sustainability score for the electric vehicle wherein the sustainability score represents the greenhouse emissions of the electric vehicle in comparison to a gas-powered vehicle for a current lifetime of the electric vehicle, and cause display of the sustainability score for the electric vehicle.

### CROSS-REFERENCE TO RELATED APPLICATIONS

This application claims priority to U.S. Provisional Patent Application No. 63/515,756, filed Jul. 26, 2023, entitled “TELEMATICS CARBON EMISSION TRACKER TOOL AND METHOD,” and U.S. Provisional Patent Application No. 63/609,678, filed Dec. 13, 2023, entitled “TELEMATICS CARBON EMISSION TRACKER TOOL AND METHOD,” the entire contents of which are hereby incorporated herein by reference in their entirety.

### FIELD OF THE DISCLOSURE

The present disclosure generally relates to collecting telematics data for a vehicle and, more particularly, to a telematics system for determining a carbon footprint of a full electric vehicle and/or a partial electric vehicle using telematics data for the vehicle.

### BACKGROUND

People are buying electric vehicles (EVs), such as full or partial electric vehicles (e.g., hybrids), for a number of reasons including that electric vehicles (EVs) generally emit less greenhouses gases during operation than a comparable gas-powered vehicle, and, therefore, help to reduce air pollution and/or global warming. However, it has been observed that the production of a gas-powered vehicle generally may emit 50% less carbon dioxide as compared to the production of an electric vehicle. Thus, an electrical vehicle may actually have a higher carbon footprint during its production process as compared to a gas-powered vehicle.

While the electric vehicle may have a lower carbon footprint during use of the vehicle, the actual greenhouse emission of the electric vehicle may also depend on the source of the electricity used for charging the batteries of the electric vehicle. A “dirty” source of electricity may emit the same amount of greenhouse gases per mile as an average gas-powered vehicle. Accordingly, an electric vehicle which may have created almost double the greenhouse emission during production of the vehicle may also fail to contribute to reduced air pollution and/or global warming during its use, if the batteries of the electric vehicle are charged using an electric source that generates electricity using fossil fuel such as coal, oil, and/or natural gas. These are all factors that consumers may want to consider when considering the overall impact of a vehicle on air pollution and/or global warming.

Accordingly, there exists a need to help electric vehicle owners or likely purchasers of EVs to track the greenhouse emissions of their vehicles during the operation of their electric vehicles and be able to select electricity sources that have lower greenhouse emission, and thereby maximize the reduction of greenhouse emissions during the life of the electric vehicle as compared to a gas-powered vehicle. Conventional techniques may have other inefficiencies, encumbrances, inefficiencies, and drawbacks as well.

### BRIEF SUMMARY

The present embodiments may relate to, inter alia, a telematics system for determining an overall carbon footprint of an electric vehicle (e.g., a full electric vehicle, and/or a partial electric vehicle), and assisting an owner of the electric vehicle to select a source of electricity for charging a battery or batteries of the electric vehicle that has a lower carbon footprint or lower greenhouse emissions than other sources of electricity. As described herein, greenhouse emissions may refer generally to the emission of carbon dioxide, methane and/or other contaminants capable of damaging the environment. In the case of measuring greenhouse emissions relating to an electric vehicle, either a partial electric vehicle (hybrid) or a full electric vehicle, greenhouse emissions may include carbon dioxide, methane and/or other contaminants produced as a result of using fossil fuels to manufacture and/or operate an electric vehicle including generating the electricity required to operate the electric vehicle.

In one aspect, a telematics system for tracking carbon emissions and determining a sustainability score for an electric vehicle may be provided. The system may include one or more local or remote processors, servers, transceivers, sensors, memory units, augmented reality glasses or headsets, virtual reality headsets, extended or mixed reality headsets, smart glasses or watches, wearables, voice bot or chatbot, ChatGPT bot, and/or other electronic or electrical components, which may be in wired or wireless communication with one another. For instance, in one example, the telematics system may include at least one processor that is in communication with at least memory. The at least one processor may be configured to: (i) receive information corresponding to a first charging station where an electric vehicle is charged; (ii) generate a first message including the received information corresponding to the first charging station; (iii) transmit the first message to an application server; (iv) receive, from the application server, a second message, wherein the second message includes greenhouse emissions information corresponding to a unit of electricity provided by the first charging station for charging the electric vehicle; (v) determine a total number of units of electricity outputted for charging a battery of the electric vehicle at the first charging station; (vi) determine a number of units of electricity stored in the battery consumed for operating the electric vehicle for a predetermined criterion; (vii) based upon the number of consumed units of electricity and the greenhouse emissions information included in the second message, determine an amount of greenhouse emissions by the electric vehicle for the predetermined criterion; (viii) based upon the determined amount of greenhouse emissions by the electric vehicle for the predetermined criterion, determine a sustainability score for the electric vehicle, wherein the sustainability score represents the greenhouse emissions of the electric vehicle in comparison to a gas-powered vehicle for a current lifetime of the electric vehicle; and (ix) cause display of the sustainability score for the electric vehicle. The computer system may include additional, less, or alternate functionality, including that discussed elsewhere herein.

In another aspect, a computing device for tracking carbon emissions and generating a sustainability score for an electric vehicle may be provided. The device may include one or more local or remote processors, servers, transceivers, sensors, memory units, augmented reality glasses or headsets, virtual reality headsets, extended or mixed reality headsets, smart glasses or watches, wearables, voice bot or chatbot, ChatGPT bot, and/or other electronic or electrical components, which may be in wired or wireless communication with one another. For instance, in one example, the computing device may include at least one display, at least one memory, and at least one processor in communication with the at least one memory. The at least one processor may be configured to: (i) receive information corresponding to a first charging station where an electric vehicle is charged; (ii) generate a first message including the received information corresponding to the first charging station; (iii) transmit the first message to a backend system; (iv) receive, from the backend system, a second message, wherein the second message includes greenhouse emissions information corresponding to a unit of electricity provided by the first charging station for charging the electric vehicle; (v) receive a total number of units of electricity outputted for charging a battery of the electric vehicle at the first charging station; (vi) receive a number of units of electricity stored in the battery consumed for operating the electric vehicle for a predetermined criterion; (vii) based upon the number of consumed units of electricity and the greenhouse emissions information included in the second message, determine an amount of greenhouse emissions by the electric vehicle for the predetermined criterion; (viii) based upon the determined amount of greenhouse emissions by the electric vehicle for the predetermined criterion, determine a sustainability score for the electric vehicle, wherein the sustainability score represents the greenhouse emissions of the electric vehicle in comparison to a gas-powered vehicle for a current lifetime of the electric vehicle; and (ix) cause to be displayed, on the at least one display, the determined electric vehicle sustainability score. The user computing device may include additional, less, or alternate functionality, including that discussed elsewhere herein.

In yet another aspect, a computer-implemented method for tracking carbon emissions and determining a sustainability score for an electric vehicle may be provided. The method may be implemented via one or more local or remote processors, servers, transceivers, sensors, memory units, augmented reality glasses or headsets, virtual reality headsets, extended or mixed reality headsets, smart glasses or watches, wearables, voice bot or chatbot, ChatGPT bot, and/or other electronic or electrical components, which may be in wired or wireless communication with one another. For instance, in one example, the method may include: (i) receiving information corresponding to a charging station where an electric vehicle is charged; (ii) generating a first message including the received information corresponding to the charging station; (iii) transmitting the first message to an application server; (iv) receiving a second message from the application server, the second message including greenhouse emissions information corresponding to a unit of electricity provided by the charging station for charging the electric vehicle; (v) determining a total number of units of electricity outputted for charging a battery of the electric vehicle at the charging station; (vi) determining a number of units of electricity stored in the battery consumed for operating the electric vehicle for a predetermined criterion; (vii) based upon the number of consumed units of electricity and the greenhouse emissions information included in the second message, determining an amount of greenhouse emissions by the electric vehicle for the predetermined criterion; (viii) based upon the determined amount of greenhouse emissions by the electric vehicle for the predetermined criterion, determining a sustainability score for the electric vehicle, wherein the sustainability score represents the greenhouse emissions of the electric vehicle in comparison to a gas-powered vehicle for a current lifetime of the electric vehicle; and (ix) causing to display the determined electric vehicle sustainability score. The computer-implemented method may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed herein. However, it should be understood that the present embodiments are not limited to the precise arrangements and/or instrumentalities shown herein.

FIG. 1 depicts an exemplary configuration of a telematics system for determining a carbon footprint of a vehicle in accordance with one embodiment of the present disclosure.

FIG. 2 depicts an exemplary configuration of a user device or user equipment for use with the telematics system of FIG. 1 in accordance with one embodiment of the present disclosure.

FIG. 3 depicts an exemplary configuration of an application server for use with the telematics system of FIG. 1 in accordance with one embodiment of the present disclosure.

FIG. 4 depicts a flow-chart of exemplary computer-implemented method operations for generating and displaying an electric vehicle sustainability score in accordance with one embodiment of the present disclosure.

FIGS. 5A-5C are exemplary views or user interfaces of a frontend application executing on the user device or the user equipment shown in FIG. 2 in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

Various embodiments in the present disclosure may relate to, inter alia, a telematic system for assisting an owner of an electric vehicle (or someone who may be considering purchasing an EV) to track overall greenhouse emissions of the electric vehicle. The telematic system may track and present data corresponding to greenhouse emissions by the electric vehicle on a per mile basis and/or for a lifetime of the electric vehicle (e.g., greenhouse emission during the production of the electric vehicle and since the electric vehicle is released from an assembly line and put into use). The greenhouse emissions as described herein may refer to the emission of carbon dioxide and methane and/or other contaminants as a result of using fossil fuel to manufacture an electric vehicle, and/or generating the electricity required to drive and/or operate the electric vehicle.

While a partial electric vehicle may operate by using a fossil fuel and an electrically charged battery(ies), a full electric vehicle may operate entirely from a battery charged with electricity. As used herein, the term battery of an EV may also include multiple batteries linked together within an EV for operating the EV. The partial electric vehicle may include a plug-in hybrid electric vehicle. A battery of an electric vehicle (such as the full electric vehicle and/or the plug-in hybrid electric vehicle) may be charged using off-board electrical power sources (generally an electricity grid). Different electricity grids may produce electricity from different sources, such as coal, oil, natural gas, wind energy, kinetic energy of flowing water, solar energy, and/or nuclear energy, and so on. Therefore, even though there may be no “tailpipe emissions” for a full electric vehicle, there may still be greenhouse emissions associated with the production of the electricity provided by the electricity grid and consumed for charging a battery of the electric vehicle. The system and method described herein takes into account the emissions generated from the production of electricity used to charge an EV.

Each electric vehicle's greenhouse emissions may therefore be calculated based upon information of an electric grid and/or a charging station used for charging a battery of the electric vehicle, and/or a mileage of the electric vehicle. The mileage of the electric vehicle may be measured as a number of miles driven per kilowatt hour (kWh), which is a unit of electricity. A battery of an electric vehicle may generally have a capacity to store about 0.65 kWh to 212.7 kWh of electric energy. And based upon a number of miles driven between two successive chargings of a battery of an electric vehicle and an amount of electricity in kWh required for the charging of the battery, a mileage of the electric vehicle may be determined as miles/kWh. The information of the electric grid and/or the charging station may provide greenhouse emission data per kWh of energy provided or produced by the electric grid and/or the charging station.

Accordingly, the exemplary embodiments of the telematics system, as described herein, may provide data corresponding to greenhouse emissions by the electric vehicle over a lifetime of the electric vehicle and/or for each mile driven based upon the mileage of the electric vehicle (e.g., miles/kWh) calculated or determined as discussed herein. The telematics system described herein may provide data corresponding to greenhouse emissions by the electric vehicle based upon generated and/or received telematics data (e.g., vehicle telematics data and/or home telematics data). The vehicle telematics data may include data corresponding to acceleration, braking, cornering, direction, heading, speed, navigation, vehicle electricity usage and/or charging, vehicle's fuel usage and refilling, and/or other vehicle data. The home telematics data may include data corresponding to energy or electricity usage, water usage, and/or home occupancy and/or presence, and so on. Additionally, or alternatively, the home telematics data may include smart home data and/or smart home sensor data. The home telematics data may be used to determine energy usage resulting from vehicles charging at the home along with emissions associated with generating the energy used at the home for such vehicle charges.

In some embodiments, and by way of a non-limiting example, the telematics system described herein may include computing equipment installed in the electric vehicle, which may be configured to determine greenhouse emissions information based upon electric grid information and/or charging station information. A vehicle of the owner may provide information of the electric grid and/or the charging station using an input device (e.g., a keyboard on a touchscreen display, a keyboard to receive user input using a rotary controller, and/or a microphone, and so on) of the electric vehicle. The information of the electric grid may include a name of an electric utility company, and/or a zip code of the area where the vehicle owner charged the electric vehicle. The information of the charging station may include a particular charging station identification number, or it may be determined based on a GPS location of the EV when the EV is being charged (e.g., locating the charging station based upon the location of the EV being charged). Using the information of the electric grid and/or the charging station, greenhouse emission data for each kWh of electric energy may be obtained by contacting an application server. The application server may be a third-party application server, and which may provide greenhouse emission data for each kWh using application programming interface (API) messages. By way of a non-limiting example, the API messages may be based upon Representational State Transfer Application (REST), simple object access protocol (SOAP), graph query language (GraphQL), webhook, remote procedure call (RPC), and so on.

The computing device may record a number of miles driven by the electric vehicle when the electric vehicle is being charged. Depending on the number of miles being driven up to a previous charging of the electric vehicle, a number of miles driven by the electric vehicle between two successive charges may be calculated. Thus, based upon the greenhouse information corresponding to an electric grid and/or a charging station where the electric vehicle is previously charged, and an amount of kWh energy consumed to drive the number of miles, a total greenhouse emission for the number of miles may be calculated by multiplying the greenhouse emission per kWh with the amount of kWh energy consumed to drive the number of miles. The greenhouse emission data may be updated during each charging of the electric vehicle.

Additionally, or alternatively, current available electric energy and/or electric energy consumed from the battery of the electric vehicle may be monitored, and based upon the number of miles driven since the last charging of the electric vehicle and the greenhouse emission information per kWh (corresponding to the electric grid and/or the charging station), greenhouse emissions by the electric vehicle may be calculated or determined in real-time (or near real-time), and may be displayed, for example, on a console or a display of the electric vehicle or a user mobile device or other computing device.

In some embodiments, information of the electric grid may be determined using a sensor. By way of a non-limiting example, the sensor may be a global positioning system (GPS) sensor and based upon the location of the electric vehicle determined using the GPS sensor, information corresponding to the electric grid and/or a charging station may be determined using the application server. The sensor may be a camera, which may automatically scan a machine-readable image (such as a barcode and/or a quick response (QR) code). Based upon the scanned machine-readable image, greenhouse emission information for each kWh of electricity production may be received. The sensor may be a near-field communication (NFC) sensor, which may communicate with the charging station to receive greenhouse emission information for each kWh of electricity production. The greenhouse emission information for each kWh of electricity production and the current available electric energy and/or electric energy consumed from the battery of the electric vehicle may be used to calculate or determine greenhouse emissions by the electric vehicle in real-time (or near real-time), and may be displayed, for example, on a console or a display of the electric vehicle or a user mobile device or other computing device.

In some embodiments, and by way of a non-limiting example, the telematics system described herein may include a user computing device or user equipment, such as a mobile device, a smartphone, a laptop, a tablet, a smartwatch, smart glasses, and/or an internet-of-things (IoT) device, and so on, which may be configured to determine greenhouse emission information based upon information of an electric grid and/or a charging station. A vehicle of the owner may provide information of the electric grid and/or the charging station using an input device (e.g., a keyboard on a touchscreen display, a keyboard, and/or a microphone, and so on) of the user computing device or user equipment (UE). As described herein, the information of the electric grid may include a name of an electric utility company, and/or a zip code of the area where the vehicle owner charged the electric vehicle. The information of the charging station may include a particular charging station identification number. Using the information of the electric grid and/or the charging station, greenhouse emission data for each kWh of electric energy may be obtained by contacting an application server, as described herein.

A user of the user computing device may provide a number of miles driven by the electric vehicle when the electric vehicle is being charged (or that data may be wirelessly communicated to the user computing device by the EV via a message or data signal). Depending on the number of miles being driven up to a previous charging of the electric vehicle, a number of miles driven by the electric vehicle between two successive charges may be calculated. Thus, based upon the greenhouse information corresponding to an electric grid and/or a charging station where the electric vehicle is previously charged, and an amount kWh energy consumed to drive the number of miles, total greenhouse emissions for the number of miles may be calculated by multiplying the greenhouse emission per kWh with the amount of kWh energy consumed to drive the number of miles. The greenhouse emission data may be updated and displayed on the user equipment.

By way of a non-limiting example, a frontend application executing on the user computing device may perform various operations described herein including, but not limited to, receiving information corresponding to the electric grid and/or charging station, receiving or calculating a number of miles driven between two successive charging of the electric vehicle, and/or receiving a total number of kWh electricity used for charging (the battery of) the electric vehicle.

In some embodiments, and by way of an example, the user computing device or user equipment may be synced and/or linked with the electric vehicle and may receive information corresponding to a number of miles driven between two successive charging of the electric vehicle, and/or a total number of kWh electricity used for charging (the battery of) the electric vehicle from the electric vehicle using Bluetooth, Wi-Fi, 4G, 5G, and/or NFC.

The user computing device may also receive from the electric vehicle current available electric energy and/or electric energy consumed from the battery of the electric vehicle. Based upon the number of miles driven since the last charging of the electric vehicle (as received from the electric vehicle and/or determined by the user equipment) and greenhouse emission information per kWh (corresponding to the electric grid and/or the charging station), greenhouse emissions by the electric vehicle may be calculated or determined in real-time (or near real-time), and may be displayed, for example, in a user interview view of the frontend application on a display device of the electric vehicle.

In some embodiments, a sensor of the user computing device may be used to receive information of the electric grid and/or the charging station used for charging of the electric vehicle, as described herein. By way of a non-limiting example, the sensor may be a global positioning system (GPS) sensor, a camera, and/or an NFC sensor of the user equipment. Also, as described herein, the user computing device may also receive additional or updated mileage details of the vehicle from a user input or from may automatically receive this additional or updated data using the GPS sensor of the EV or the user computing device.

In some embodiments, an electric vehicle may be a hybrid vehicle, which is operable using both gasoline (or diesel fuel) and electricity. In such cases, the telematics system may determine or calculate how many miles are driven using gasoline (or diesel), and how many miles are driven using electric power from the battery of the electric vehicle. The telematics system may determine greenhouse emissions by the hybrid vehicle based upon an amount of used gasoline (or diesel) and an amount of kWh energy (and corresponding greenhouse emission information per kWh for the respective electric grid and/or the charging station).

By way of a non-limiting example, the greenhouse emission information calculated or determined by the telematics system may be referenced herein as an electric vehicle (EV) sustainability score. The EV sustainability score may represent an amount of greenhouse emissions by the electric or hybrid vehicle over the lifetime of the electric vehicle and/or an amount of greenhouse emissions in comparison with a gas-powered vehicle (e.g., a similar sized gas-powered vehicle having the same manufacturing year and similar number of odometer miles). The EV sustainability score may be represented using a number and/or a letter. Additionally, or alternatively, the greenhouse emissions by the electric or hybrid vehicle may be presented as a graph. By way of a non-limiting example, the graph may present greenhouse emission information in comparison with the gas, powered vehicle. The graph may be a comparison bar chart, a slope chart, a tornado chart, a pie chart, a donut chart, and/or a matrix chart, and so on. The EV sustainability score may thus indicate when the electric vehicle, which may have had almost double the greenhouse emissions during the production of the electric vehicle, starts to have less greenhouse emissions in comparison with the gas-powered vehicle during operation of the vehicle. Additionally, or alternatively, the telematics system may be configured to display greenhouse emission information corresponding to a user provided time period (e.g., between a first date and a second date, in a particular month of a year, and/or in a specific week of a month).

In some embodiments, the telematic system described herein may display available charging stations within a predetermined radius area of a current location of the electric vehicle. Additionally, or alternatively, the telematics system may display associated greenhouse emission information and/or a battery charging speed corresponding to one or more charging stations of the available charging stations, such that the electric vehicle may be charged using a charging station having a lesser impact on greenhouse emissions. The telematics system may display the available charging stations using a map and/or a navigation system installed in the electric vehicle, and/or on a frontend application executing on a user equipment linked or synchronized with the electric vehicle.

In some embodiments, the telematics system may display advertisements and/or promotions on the display of the user computing device linked or synchronized with the electric vehicle and/or on the display of the electric vehicle. By way of a non-limiting example, the advertisements and/or promotions may be related to installation of solar panels at home of the owner of the electric vehicle to charge the electric vehicle using solar energy. Additionally, or alternatively, the telematics system may display greenhouse emission information for a trip based upon the user provided starting and ending destinations using different modes of transportation (e.g., bus, train, airplane, bicycle, motorcycle, and/or the vehicle owner's electric vehicle or autonomous electric vehicle).

As used herein, the telematics system collects, processes, analyzes, stores, and transmits telematics data. Telematics data may include vehicle telematics data, home telematics data, and/or other data used to generate outputs described herein. For example, vehicle telematics data may include, but is not limited to, ABC data (e.g., acceleration, braking, cornering data), along with direction, heading, speed, and other vehicle or navigation data, or mileage, tire condition, maintenance or repair histories, vehicle part status, vehicle type, make and model, vehicle expected mileage on a charge or tank of fuel, and the like.

The home telematics data may include, but is not limited to, energy or electricity usage data for the home, water usage data, smart home data, smart home sensor data, home occupancy or presence data, etc. It may also include home health data (e.g., weather data, seismic activity data, flooding data, or the like), electrical fire data, theft or vandalism of property, aging appliances or heating, ventilation and air conditioning (HVAC), or the like, or other home data that may positively or negatively impact risks or energy consumption at the home. The home telematics data may also include power usage data, power sources (e.g., utility companies), home solar panel data, other power sources, water usage, current temperatures, doors and/or windows open or closed, as well as current and future weather conditions and other parameters that may affect the home. The telematics data may be collected from some external sources (e.g., publicly available data, such as historical weather-related information or power outage statistics for the area, emergency service response statistics for the area, or the like) or from home sources (e.g., data gathered from sensors, appliances, or networked devices within and/or around the house). The system may gather such data from access to data from different monitors and other devices in the home, such as Internet of Things (IoT) devices. The IoT devices may provide their data directly and/or provide data through servers associated with and in communication with the IoT devices. The home telematics data may also be included in the sustainability score for the vehicles to provide an overall sustainability score for the user.

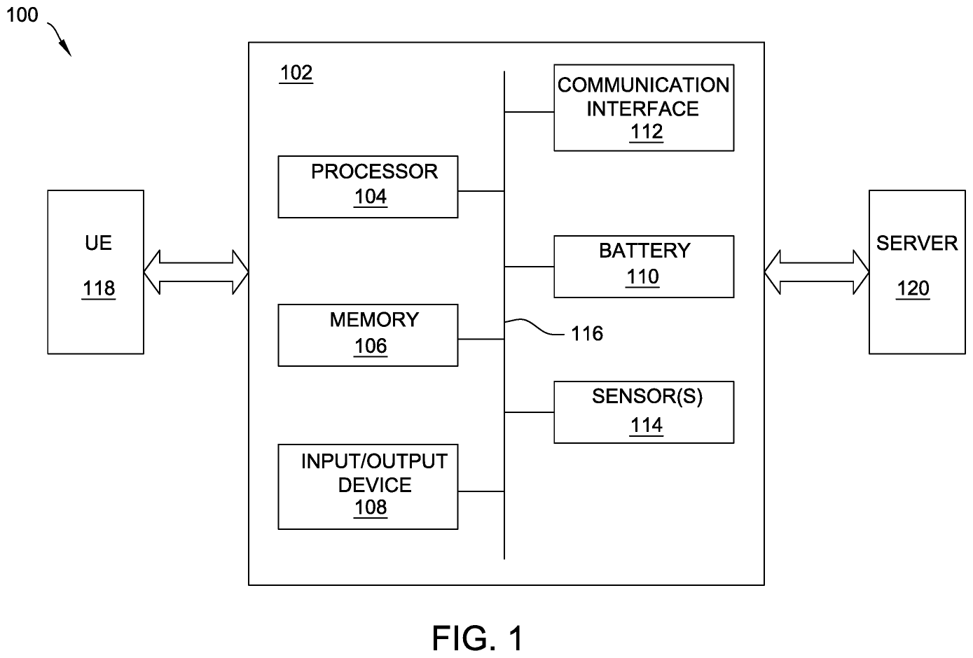

The various embodiments in the present disclosure thus provide solutions to track greenhouse emissions and choose electric sources that have lower greenhouse emissions, and thereby reduce greenhouse emissions during the life of the electric vehicle compared to the gas-powered vehicle. These embodiments are described herein in greater detail using FIGS. 1-FIGS. 5C below.

### Exemplary Telematics System

FIG. 1 depicts an exemplary telematics system 100 of an electric vehicle 102 in accordance with embodiments of the present disclosure. The electric vehicle 102 may be a full electric vehicle or a partial electric vehicle (e.g., a hybrid vehicle) being operated by a battery or batteries 110. The battery 110 may be a bank of batteries providing electric power to drive the electric vehicle 102. The battery 110 may be charged by connecting the battery of the electric vehicle 102 to a charging station. The electric vehicle may include one or more sensors 114, for example, to measure available kWh electric energy from the battery 110, to measure kWh electric energy from the battery 110 consumed for operating the electric vehicle 102, and/or to measure gasoline (or diesel) consumed for operating the electric vehicle. The one or more sensors 114 may also include an odometer or GPS system to measure a number of miles driven or traveled by the electric vehicle 102.

A communication interface 112 may provide communication with a user equipment (UE) or user computing device 118 and/or a server 120. The server 120 may be an application server described herein, and the user equipment 118 may be a user equipment such as a mobile device, a laptop or other computing device, a smartphone, a tablet, a smartwatch, smart glasses, an augmented reality (AR) glasses, and/or an internet-of-things (IoT), and so on. The communication interface 112 may provide communication with the user equipment or user computing device 118 and/or the server using Wi-Fi, Bluetooth, a 3G network, a 4G network, a 5G network, a 6G network, an Internet, and/or a satellite network, and so on.

An application (not shown in FIG. 1) executing on the user equipment 118 may communicate with an application executing on a processor 104 via the communication interface 112. The application executing on the user equipment 118 may be referenced herein as a frontend application, which may be a mobile application, a web browser application, and/or a native application. The application executing on the processor 104 and/or server 120 may be a backend application. In other words, the application executing on the user equipment 118 and the application executing on the processor 104 may be in a client-server mode. Using the frontend application executing on the UE 118, a user may provide information such as information of an electric grid and/or a charging station using an input device (not shown in FIG. 1) of the user equipment 118. Also, greenhouse emission information of the electric vehicle 102 may be displayed on an output device (not shown in FIG. 1) of the user equipment 118.

The backend application executing on the processor 104 may receive information such as information of an electric grid and/or a charging station from the frontend application executing on the user equipment 118. Additionally, or alternatively, the backend application executing on the processor 104 and/or server 120 may receive the information via an input/output device 108. The input/output device 108 may be a touchscreen display with a touchscreen keyboard, a keyboard, a microphone, and/or a display, and so on. The backend application may also receive the electric grid and charging station information using (i) a GPS system of the vehicle that helps to locate the vehicle and the charging station being used, and (ii) a lookup within an internal or external memory for storing information about the grid and/or charging station. The backend application executing on the processor 104 may display greenhouse emission information of the electric vehicle 102 on the input/output device 108.

A memory 106 may store the information corresponding to the electric grid and/or the charging station, calculated greenhouse emission information including historical greenhouse emission information, and so on. The memory 106 may also store information corresponding to trip details including starting and ending destinations. The backend application executing on the processor 104 may act as a frontend application while communicating with an application executing on the server 120, which is referenced herein as a backend application executing on the server 120. As the frontend application executing on the processor 104, the frontend application may receive data including greenhouse emission information for the electric grid and/or charging station, details of nearby charging stations and their greenhouse emission information, and so on, from the server 120.

The frontend application executing on the user equipment or user computing device 118 and/or the processor 104 and the backend application executing on the processor 104 and/or the server 120 may communicate data including one or more images, one or more video data files, text, and/or voice, and so on, as a webservice message over a hypertext transfer protocol (http) or a hypertext transfer protocol secure (https) protocol. The webservice message may be according to a Representational State Transfer (REST) application programming interface (API), a Simple Object Access Protocol (SOAP) API, a graph query language (GraphQL) API, a webhook API, and/or remote procedure call (RPC), and so on. The data may be communicated as (i) an extended markup language (XML), (ii) a JavaScript Object Notation (JSON), (iii) a Concise Binary Object Representation (CBOR), (iv) hypertext markup language (html), (v) a binary JSON (BSON), (vi) protocol buffers, and (vii) so on.

The processor 104, the memory 106, the input/output device 108, the communication interface 112, the battery 110, and/or the one or more sensors 114 may be communicatively coupled via a bus 116. By way of a non-limiting example, the bus 116 may be a controller area network (CAN) bus.

### Exemplary Computing Device

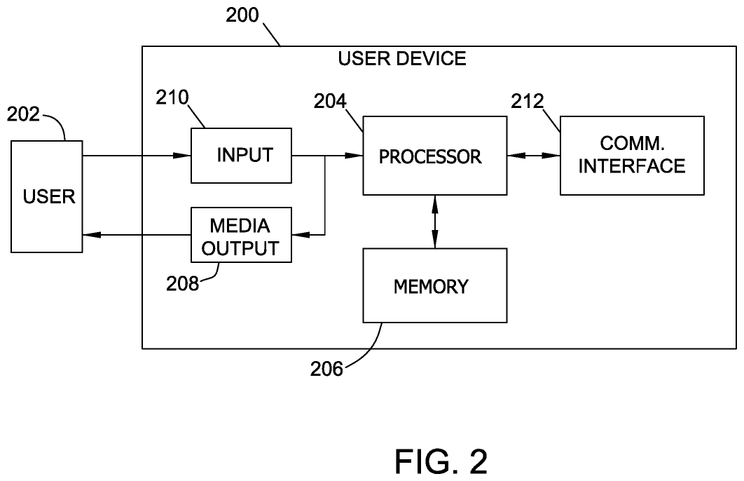

FIG. 2 depicts an exemplary configuration of a user computing device 200, in accordance with one embodiment of the present disclosure. User computing device 200 may be similar to the user equipment or user device 118 and operated by a user 202, such as an owner of the electric vehicle 102. User computing device 200 may include, but is not limited to, a smart phone, a tablet, a laptop, an electronic device equipped with at least one visual sensor. Additionally, or alternatively, user computing device 200 may be, for example, a mobile device, smart home controller, smart vehicle, smart watch, smart contact lenses, augmented reality glasses, virtual reality headset, mixed or extended reality headset or glasses, wearables, voice or chat bot, ChatGPT or ChatGPT-based bot, other input device, and/or other electronic or electrical devices.

User computing device 200 may include at least one processor 204 for executing instructions. In some embodiments, executable instructions may be stored in a memory 206. Processor 204 may include one or more processing units (e.g., in a multi-core configuration). Memory 206 may be any device allowing information such as executable instructions and/or transaction data to be stored and retrieved. Memory 206 may include one or more computer readable media.

User computing device 200 may also include at least one media output component 208 for presenting information to user 202. Media output component 208 may be any component capable of conveying information to user 202. In some embodiments, media output component 208 may include an output adapter (not shown) such as a video adapter and/or an audio adapter. An output adapter may be operatively coupled to processor 204 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 208 may be configured to present a graphical user interface (e.g., a web browser and/or a client application) to user 202. A graphical user interface may include, for example, an interface for viewing prompts and data. In some embodiments, user computing device 200 may include an input 210 for receiving input from user 202. User 202 may use input 210 to, without limitation, provide user input.

Input device 210 may include, for example, a keyboard, a pointing device, a mouse, a stylus, a touch sensitive panel (e.g., a touch pad or a touch screen), a gyroscope, an accelerometer, a position detector, a biometric input device, at least one vision sensor (e.g., a camera or a video camera), and/or an audio input device. A single component such as a touch screen may function as both an output device of media output component 208 and input device 210.

User computing device 200 may also include a communication interface 212, communicatively coupled to a backend system or an application server, which may be the electric vehicle 102 and the server 120. Communication interface 212 may include, for example, a wired or wireless network adapter and/or a wireless data transceiver for use with a mobile telecommunications network.

Stored in memory 206 are, for example, computer readable instructions for providing a user interface to user 202 via media output component 208 and, optionally, receiving and processing input from input 210. A user interface may include, among other possibilities, a web browser and/or a client application. Web browsers enable users, such as user 202, to display and interact with media and other information typically embedded on a web page or a website from the backend system. A client application (e.g., a frontend application executing on the user device 200) may allow user 202 to interact with, for example, the backend system.

In one embodiment, the user device 200 may be part of the telematics system described herein. The telematics system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the telematics system may include the user device 200 and/or a server computing device that may include at least one processor in communication with at least one memory device.

In another embodiment, user device 200 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In some embodiments, generative artificial intelligence (AI) models (also referred to as generative machine learning (ML) models) may be utilized with the present embodiments, and the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

### Exemplary Application Server

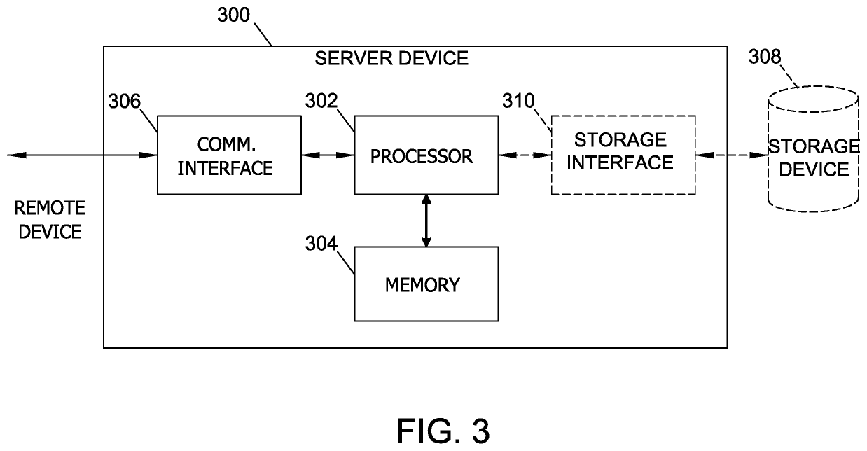

FIG. 3 depicts an exemplary configuration of an application server 300 of a backend system, in accordance with one embodiment of the present disclosure. Application server 300 may be similar to the server 120 and/or the computing devices included on the electric vehicle 102, and may be configured to perform various steps, as described herein, from the backend system perspective. Processor 302 may include one or more processing units (e.g., in a multi-core configuration). Processor 302 may be operatively coupled to a communication interface 306 such that the application server 300 is capable of communicating with a remote device, such as another application server 300, the user equipment 118, and/or the electric vehicle 102, for example, using wireless communication or data transmission over one or more radio links or digital communication channels. For example, communication interface 306 may receive data, e.g., image, video, text, and so on.

Processor 302 may also be operatively coupled to a storage device 308. Storage device 208 may be any computer-operated hardware suitable for storing and/or retrieving data, such as, but not limited to, data associated with historic databases. In some embodiments, storage device 308 may be integrated in the application server 300. For example, the application server 300 may include one or more hard disk drives as storage device 308.

In other embodiments, storage device 308 may be external to host computing device 300 and may be accessed by a plurality of host computing devices 300. For example, storage device 308 may include a storage area network (SAN), a network attached storage (NAS) system, and/or multiple storage units such as hard disks and/or solid-state disks in a redundant array of inexpensive disks (RAID) configuration.

In some embodiments, processor 302 may be operatively coupled to storage device 308 via a storage interface 310. Storage interface 310 may be any component capable of providing processor 302 with access to storage device 308. Storage interface 310 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to storage device 208.

Processor 302 may execute computer-executable instructions for implementing aspects of the disclosure. In some embodiments, the processor 302 may be transformed into a special purpose microprocessor by executing computer-executable instructions or by otherwise being programmed. In some embodiments, and by way of a non-limiting example, the memory 304 may include instructions to perform specific operations, as described herein.

### Exemplary Computer-Implemented Method

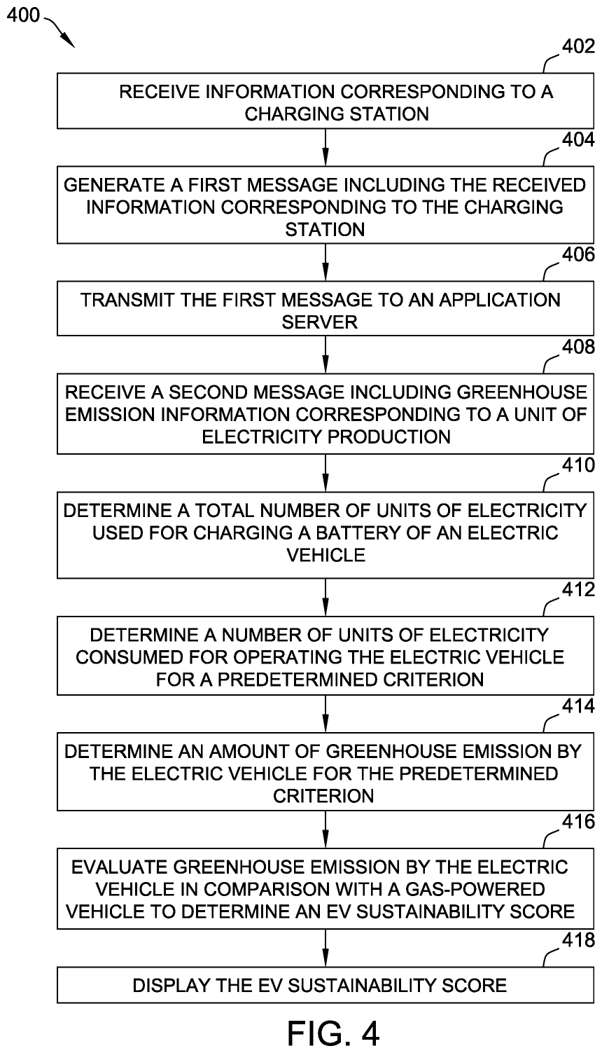

FIG. 4 depicts a flow-chart 400 of exemplary computer-implemented method operations performed by at least one computing device and/or processor of the telematics system described herein, which may be installed in an electric vehicle or in communication with an EV. A user computing device or user equipment (UE) may be linked or synchronized with the electric vehicle. By way of a non-limiting example, the user computing device and the electric vehicle may be in direct communication with each other using Wi-Fi, Bluetooth, a local area network, a wide area network, an Internet, a 3G network, a 4G network, a 5G network, and/or a 6G network, and so on. Additionally, or alternatively, the user computing device or user equipment and the electric vehicle may be in indirect communication via an application server.

Information corresponding to a charging station where an electric vehicle is being charged may be received (402) by the telematics system. The received information corresponding to the charging station may include an identifier of the charging station and/or a location of the charging station. The identifier of the charging station and/or the location of the charging station may be received as user input or from a GPS system of the vehicle. The user input may be received at the telematics system installed in the electric vehicle using an input device installed in the electric vehicle, which may be a touchscreen display, a microphone, a keyboard, and/or a keyboard using a knob controller, and so on. The user input may be received at the user computing device or user equipment similarly using a touchscreen display, a microphone, and/or a keyboard, and so on, and communicated to the telematics system. The location of the charging station may be received or determined from a GPS device on the electric vehicle and/or the user equipment. Once the telematics system has the GPS data, it may be able to determine a location and other information relative to the charging station being used to charge the vehicle.

By way of a non-limiting example, the identifier of the charging station may be identified using a sensor (e.g., a camera, and/or an NFC sensor) of the electric vehicle, and the location of the charging station may be identified using a sensor (e.g., a GPS sensor) of the electric vehicle. Additionally, or alternatively, the identifier of the charging station may be identified using a sensor (e.g., a camera, and/or an NFC sensor) of the user equipment, and the location of the charging station may be identified using a sensor (e.g., a GPS sensor) of the user equipment. The identifier and the location of the charging station identified using the one or more sensors of the user computing device or user equipment may be communicated to the electric vehicle, as described herein. The identifier of the charging station may be a machine-readable image such as a barcode and/or a QR code. The identifier of the charging station may be a serial number, which may be automatically identified using a camera, and optical character recognition technique.

A first message including the information corresponding to the charging station may be generated (404). The first message may be an application programming interface (API) message, as described herein. The generated message may include an identifier and/or a location of the charging station. The charging station may be at a residence, and/or a public or private charging stations. The generated first message may be transmitted (406) to an application server. The application server may be configured to identify a provider of the electricity at the particular charging station using the information corresponding to the charging station included in the received first message. In particular, a location and/or an identifier of the charging station may be used to identify the provider of electricity at the particular charging station.

Upon identifying the provider of electricity, the application server may use one or more API messages to the provider of the electricity at the charging station to receive greenhouse emission information corresponding to production of electricity. By way of a non-limiting example, the greenhouse emission information corresponding to production of electricity may be represented as greenhouse emission for each unit of electricity (e.g., kWh). As described herein, the electricity may be produced from one or more sources (e.g., coal, oil, natural gas, wind energy, kinetic energy of flowing water, solar energy, and/or nuclear energy, and so on), and the greenhouse emissions may depend on the one or more sources used for electricity generation. The application server may build and send a second message including greenhouse emission information corresponding to a unit of electricity provided by the charging station for charging the electric vehicle. The second message may be received (408) by the telematics system including by one or all of the backend server, the processor/controller at the EV, and/or the user computing device.

The telematics system may determine (410) a total number of units of electricity (e.g., in kWh) used for charging a battery of the electric vehicle at the charging station. As the electric vehicle is being operated, power or energy to operate the electric vehicle may be drawn from the battery, and a number of units of electricity stored in the battery consumed for operating the electric vehicle for a predetermined criterion may be determined (412). The predetermined criterion may be a predetermined time period (e.g., every fifteen minutes, every ten minutes, every thirty minutes, every hour, and/or a user provided time period), or a predetermined distance travelled by the electric vehicle (e.g., every ten miles, every twenty-five miles, and/or a user provided distance value).

Based upon the number of consumed units of electricity determined (412) and in accordance with the received second message (408), an amount of greenhouse emission by the electric vehicle for the predetermined criterion may be determined (414) in one example by multiplying the greenhouse emission per unit of electricity production with the total number of units of electricity consumed for the predetermined criterion. The greenhouse emissions by the electric vehicle determined (414) may be compared with greenhouse emissions of a gas-powered vehicle for evaluating (416) greenhouse emissions of the electric vehicle with the gas-powered vehicle for a lifetime of the electric vehicle and for determining an electric vehicle sustainability score, as described herein. As described herein, an electric vehicle may have about twice the greenhouse emission during production in comparison with production of a gas-powered vehicle. Accordingly, the electric vehicle sustainability score that is displayed (418) may help identify when benefits of the electric vehicle in terms of reducing greenhouse emissions are realized.

By way of a non-limiting example, the electric vehicle may be a full electric vehicle or a partial electric vehicle. The partial electric vehicle may be operable using both electric energy and non-electric energy (e.g., oil and/or natural gas). In such cases, greenhouse emissions by the electric vehicle may be determined further based upon greenhouse emissions from operating the electric vehicle using non-electric energy as well.

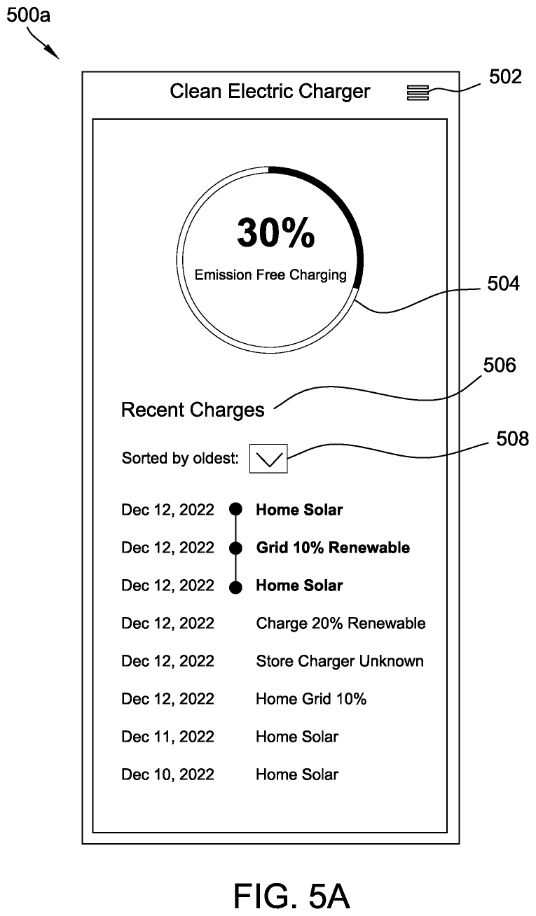

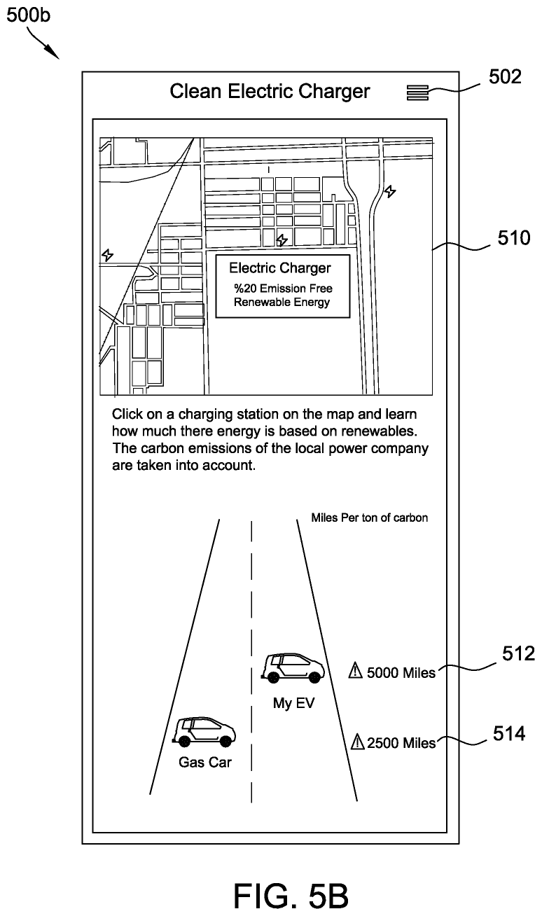

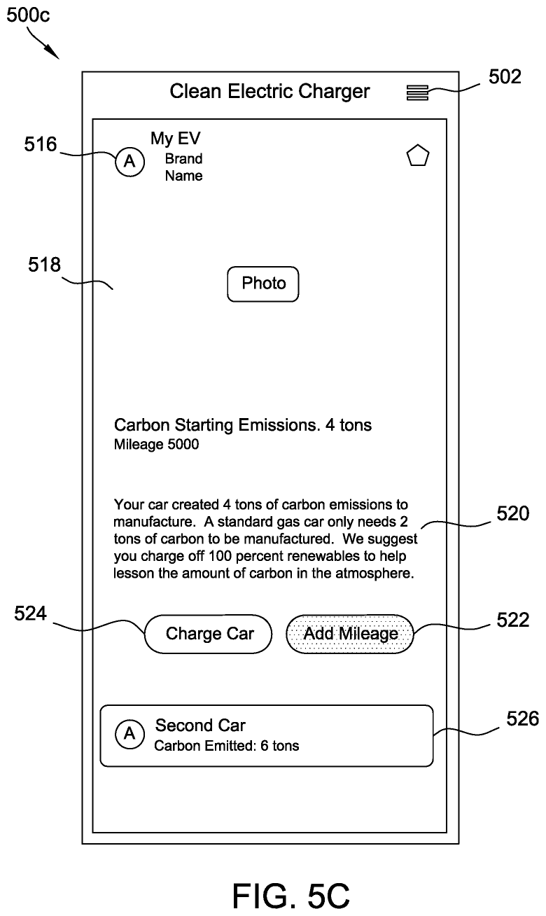

Various operations performed by the telematics system installed in the electric vehicle may also be performed by a user equipment linked or synchronized with the telematic system. The user equipment may be linked or synchronized with the telematics system using Wi-Fi, Bluetooth, a local area network, a wide area network, an Internet, a 3G network, a 4G network, a 5G network, and/or a 6G network, and so on. Additionally, or alternatively, the user equipment and the electric vehicle may be in indirect communication via an application server. A frontend application executing on the user equipment may perform some or all of the operations described herein with regards to the flow-chart 400 in communication with a backend application executing on a backend system. The backend system may be a telematics system installed in the electric vehicle and/or an application server. Exemplary views of the frontend application executing on the user equipment are described below using FIGS. 5A-5C.

### Exemplary Views of a Frontend Application

FIG. 5A is an exemplary view (or user interface or screen shot) 500a of a frontend application executing on a user computing device or user equipment, such as the user equipment shown in FIG. 2. As shown in the view 500a, a vehicle owner and/or a user of the user equipment, using the frontend application, may cause to be determined and displayed how much charging of the battery of the electric vehicle is completed without greenhouse emissions. As shown, an electronic button 502 may enable the user to access a plurality of menu options. A menu option of the plurality of menu options may include an option to review previous chargings of the battery of the electric vehicle 506 (or recent charges 506). Previous chargings of the battery of the electric vehicle may be sorted according to different criteria as shown in the view 500a as 508. Previous chargings may be sorted based upon date (e.g., sorted by oldest, sorted by newest), a type of charging source (e.g., home solar, store charger, home grid, and so on), and so on.

In some embodiments, and by way of a non-limiting example, a total number of the recent electric charges may be configurable for display in the view 500a. Additionally, or alternatively, the user may use a scroll bar to review additional charging records that are not initially displayed in the view 500a. In the example embodiment, for the recent charges 506, the user has charged the vehicle battery using clean electrical sources (emissions free) about 30% of the time, for example, using a home solar grid, a charging station providing electricity generated from wind energy, kinetic energy of flowing water, solar energy, and/or nuclear energy, and so on.

FIG. 5B depicts an exemplary view (or user interface) 500b of the frontend application as shown on the user computing device. As shown in the view 500b, using the electronic button 502, the vehicle owner and/or the user of the user computing device may search for a charging station to charge the battery of the electric vehicle. As shown in the view 500b, a map 510 may be displayed showing one or more charging stations within a predetermined or configurable threshold distance of a location. By way of a non-limiting example, the location may be received as a user input and/or using a GPS of the user equipment and/or the electric vehicle. When the user of the user equipment brings a cursor within a predetermined threshold distance from a graphical element corresponding to the charging station displayed in the map 510, the user may cause to be displayed additional details including how the electricity provided by the charging station is generated. Additionally, or alternatively, a comparison of the electric vehicle with a gas-powered vehicle with respect to a number of miles of driving the vehicle to emit one ton of greenhouse carbon emissions, as shown in the view 500b as 512 and 514, may be displayed.

FIG. 5C depicts an exemplary view 500c of the frontend application executing on a user computing device or on the EV itself. As shown in the view 500c, using the electronic button 502, the vehicle owner and/or the user of the user equipment may add details about one or more vehicles owned by the user of the user equipment. As shown in the view 500c, the user may add vehicle details including, but not limited to, a brand name of the vehicle (e.g., an electric vehicle, a non-electric vehicle, a hybrid electric vehicle) 516, and/or a photo of the vehicle 518. Additionally, or alternatively, current greenhouse emissions for the vehicle, current mileage details of the vehicle, and/or a message (e.g., describing how to reduce greenhouse emissions) may be displayed as shown in the view 500c as 520. The user may add or update mileage details of the vehicle using a selectable option 522, and/or add or update vehicle details using a selectable option 524. Additionally, or alternatively, the user may use a selectable option in the frontend application to automatically track miles via the GPS system of the user equipment or the vehicle. If the user has another vehicle, details about the other vehicle (e.g., the user provided custom name of the vehicle and the greenhouse emission details) may be displayed as shown in the view 500c as 526.

### Machine Learning and Other Matters

The computer-implemented method and system discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the server computing device is configured to implement machine learning, such that server computing device “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include, but are not limited to, images and other data that may be used by the telematic system for assisting an owner of an electric vehicle (or someone who may be considering purchasing an EV) to track overall greenhouse emissions of an electric vehicle. For example, in those cases where certain data used to calculate emissions is unavailable to the telematics system, the system may be able to use ML and/or AI tools to estimate or predict these missing data parameters so as to then be able to calculate the emissions for the EV vehicle or for a gas power vehicle for comparison purposes. ML outputs may include, but are not limited to identified objects, items classifications, other data extracted from the images, and/or estimated emissions or other data points needed to make such emission estimates. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of home attributes with known characteristics or features. Such information may include, for example, information associated with a plurality of vehicle devices, charging station devices, or other devices associated with gathering charging and emissions data.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal.

Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and voice bots or chatbots may be configured to utilize artificial intelligence and/or machine learning techniques and used to implement the processes discussed herein. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption. In certain embodiments, the telematic system may utilize voice bots or chatbots to assist an owner of an electric vehicle (or someone who may be considering purchasing an EV) to track overall greenhouse emissions of the electric vehicle. The telematic system may use the voice bots or chatbots to track and present data corresponding to greenhouse emissions by the electric vehicle on a per mile basis and/or for a lifetime of the electric vehicle (e.g., greenhouse emission during the production of the electric vehicle and since the electric vehicle is released from an assembly line and put into use).

Based upon these analyses, the processing element may learn how to identify characteristics and patterns that may then be applied to analyzing and classifying objects or other data. This information may be used to determine which classification models to use and which classifications to provide.

As described herein, the telematics system may use AI and ML tools to determine an overall carbon footprint of an electric vehicle (e.g., a full electric vehicle, and/or a partial electric vehicle), and assist an owner of the electric vehicle to select a source of electricity for charging a battery or batteries of the electric vehicle that has a lower carbon footprint or a lower greenhouse emission than other sources of electricity.

### Exemplary Embodiments

In one aspect, a telematics system for generating a sustainability score for an electric vehicle, either a partial or full electric vehicle, may be provided herein. The telematics system includes at least one memory; and at least one processor in communication with the at least one memory. The at least one processor is configured to: (i) receive information corresponding to a first charging station where an electric vehicle is charged; (ii) generate a first message including the received information corresponding to the first charging station; (iii) transmit the first message to an application server; (iv) receive, from the application server, a second message, wherein the second message includes greenhouse emissions information corresponding to a unit of electricity provided by the first charging station for charging the electric vehicle; (v) determine a total number of units of electricity outputted for charging a battery of the electric vehicle at the first charging station; (vi) determine a number of units of electricity stored in the battery consumed for operating the electric vehicle for a predetermined criterion; (vii) based upon the number of consumed units of electricity and the greenhouse emissions information included in the second message, determine an amount of greenhouse emissions by the electric vehicle for the predetermined criterion; (viii) based upon the determined amount of greenhouse emissions by the electric vehicle for the predetermined criterion, determine a sustainability score for the electric vehicle, wherein the sustainability score represents the greenhouse emissions of the electric vehicle in comparison to a gas-powered vehicle for a current lifetime of the electric vehicle; and (ix) cause display of the sustainability score for the electric vehicle. The computer system may include additional, less, or alternate functionality, including that discussed elsewhere herein.

Another embodiment of the telematics system described above may include the at least one processor being further configured to receive information corresponding to the first charging station including at least one of an identifier for identifying the first charging station or a location of the first charging station.

Another embodiment of the telematics system described above may include the at least one processor being further configured to receive the identifier or the location of the first charging station via a user input or via a sensor.

Another embodiment of the telematics system described above may include the at least one processor being further configured to determine the location of the first charging station based upon data captured by a global positioning system (GPS) sensor, or wherein the identifier of the first charging station is determined based upon data captured by a camera or a near-field communication (NFC) sensor.

Another embodiment of the telematics system described above may include the at least one processor being further configured to determine the sustainability score for the electric vehicle by determining an amount of greenhouse emissions produced during production of the electric vehicle and an amount of greenhouse emissions produced during production of a similar-sized gas-powered vehicle.

Another embodiment of the telematics system described above wherein the electric vehicle sustainability score may be a number score or a letter score, and wherein the electric vehicle sustainability score represents a total amount of greenhouse emissions for the current lifetime of the electric vehicle including emissions resulting from production and operation of the electric vehicle as compared to a similar lifetime of a similar-sized gas-powered vehicle.

Another embodiment of the telematics system described above wherein the electric vehicle may be a partial electric vehicle (hybrid) or a full electric vehicle.

Another embodiment of the telematics system described above wherein the electric vehicle may be a partial electric vehicle, and wherein the at least one processor is further configured to determine the amount of greenhouse emissions by the partial electric vehicle for the predetermined criterion by: (i) determining an amount of greenhouse emissions from consumption of energy other than electric energy from the battery of the electric vehicle for the predetermining criterion; and (ii) determining the amount of greenhouse emissions by the electric vehicle from consumption of electric energy from the battery of the electric vehicle for the predetermined criterion.

Another embodiment of the telematics system described above wherein the predetermined criterion may be (i) a predetermined time period, or (ii) a predetermined distance travelled by the electric vehicle.

Another embodiment of the telematics system described above may include the at least one processor being further configured to cause display of (i) a list of one or more charging stations in an area of a preconfigured distance surrounding the electric vehicle and (ii) respective greenhouse emissions information corresponding to a unit of electricity provided by the one or more charging stations of the list.

Another embodiment of the telematics system described above wherein the telematics system may be integrated into the electric vehicle.

In another aspect, a user computing device for generating a sustainability score for an electric vehicle, either a partial or full electric vehicle, may be provided herein. The user computing device may include at least one display, at least one memory, and at least one processor in communication with the at least one memory. The at least one processor may be configured to: (i) receive information corresponding to a first charging station where an electric vehicle is charged; (ii) generate a first message including the received information corresponding to the first charging station; (iii) transmit the first message to a backend system; (iv) receive, from the backend system, a second message, wherein the second message includes greenhouse emissions information corresponding to a unit of electricity provided by the first charging station for charging the electric vehicle; (v) receive a total number of units of electricity outputted for charging a battery of the electric vehicle at the first charging station; (vi) receive a number of units of electricity stored in the battery consumed for operating the electric vehicle for a predetermined criterion; (vii) based upon the number of consumed units of electricity and the greenhouse emissions information included in the second message, determine an amount of greenhouse emissions by the electric vehicle for the predetermined criterion; (viii) based upon the determined amount of greenhouse emissions by the electric vehicle for the predetermined criterion, determine a sustainability score for the electric vehicle, wherein the sustainability score represents the greenhouse emissions of the electric vehicle in comparison to a gas-powered vehicle for a current lifetime of the electric vehicle; and (ix) cause to be displayed, on the at least one display, the determined electric vehicle sustainability score. The user computing device may include additional, less, or alternate functionality, including that discussed elsewhere herein.

Another embodiment of the user computing device described above may include the at least one processor being further configured to receive the information corresponding to the first charging station by at least one of: (i) receiving an identifier for identifying the first charging station by receiving a user input or receiving the identifier via a sensor including a camera or a near-field communication (NFC) sensor; or (ii) receiving a location of the charging station by receiving a user input or receiving sensor data from a global positioning system (GPS) sensor.

Another embodiment of the user computing device described above may include the at least one processor being further configured to determine the sustainability score of the electric vehicle by receiving, from the backend system, an amount of greenhouse emissions generated during production of the electric vehicle and an amount of greenhouse emissions generated during production of a similarly sized gas-powered vehicle.

Another embodiment of the user computing device described above wherein the electric vehicle sustainability score may be a number score or a letter score, and wherein the electric vehicle sustainability score represents a total amount of greenhouse emissions for the current lifetime of the electric vehicle including emissions resulting from production and operation of the electric vehicle as compared to a similar lifetime of a similarly sized gas-powered vehicle.

Another embodiment of the user computing device described above wherein the electric vehicle may be a partial electric vehicle or a full electric vehicle.

Another embodiment of the user computing device described above wherein the electric vehicle may be a partial electric vehicle, and wherein the at least one processor is further configured to determine the amount of greenhouse emissions by the partial electric vehicle for the predetermined criterion further by: (i) determining an amount of greenhouse emissions from consumption of energy other than electric energy from the battery of the electric vehicle for the predetermining criterion; and (ii) determining the amount of greenhouse emissions by the electric vehicle from consumption of electric energy from the battery of the electric vehicle for the predetermined criterion.

Another embodiment of the user computing device described above wherein the predetermined criterion may be a predetermined time period, or a predetermined distance travelled by the electric vehicle.

Another embodiment of the user computing device described above may include the at least one processor being further configured to cause display of (i) a list of one or more charging stations in an area of a preconfigured distance surrounding the electric vehicle and (ii) respective greenhouse emissions information corresponding to a unit of electricity provided by the one or more charging stations of the list.

In another aspect, a computer-implemented method for determining a sustainability score for an electric vehicle, either a partial electric vehicle or a full electric vehicle, may be provided. The computer-implemented method performed by a computing device including at least one processor and at least one memory device. The computer-implemented method may comprise: (i) receiving information corresponding to a charging station where an electric vehicle is charged; (ii) generating a first message including the received information corresponding to the charging station; (iii) transmitting the first message to an application server; (iv) receiving a second message from the application server, the second message including greenhouse emissions information corresponding to a unit of electricity provided by the charging station for charging the electric vehicle; (v) determining a total number of units of electricity outputted for charging a battery of the electric vehicle at the charging station; (vi) determining a number of units of electricity stored in the battery consumed for operating the electric vehicle for a predetermined criterion; (vii) based upon the number of consumed units of electricity and the greenhouse emissions information included in the second message, determining an amount of greenhouse emissions by the electric vehicle for the predetermined criterion; (viii) based upon the determined amount of greenhouse emissions by the electric vehicle for the predetermined criterion, determining a sustainability score for the electric vehicle, wherein the sustainability score represents the greenhouse emissions of the electric vehicle in comparison to a gas-powered vehicle for a current lifetime of the electric vehicle; and (ix) causing to display the determined electric vehicle sustainability score. The computer-implemented method may include additional, less, or alternate functionality, including that discussed elsewhere herein.

In another aspect, at least one non-transitory computer-readable storage media having computer-executable instructions embodied thereon may be provided. The computer-executable instructions may be executed by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer-executable instructions may be performed by at least one processor and at least one memory device. When executed by a computing device including at least one processor and at least one memory device, the computer-executable instructions cause the at least one processor to: (i) receive information corresponding to a charging station where an electric vehicle is charged; (ii) generate a first message including the received information corresponding to the charging station; (iii) transmit the first message to an application server; (iv) receive a second message from the application server, the second message including greenhouse emissions information corresponding to a unit of electricity provided by the charging station for charging the electric vehicle; (v) determine a total number of units of electricity outputted for charging a battery of the electric vehicle at the charging station; (vi) determine a number of units of electricity stored in the battery consumed for operating the electric vehicle for a predetermined criterion; (vii) based upon the number of consumed units of electricity and the greenhouse emissions information included in the second message, determine an amount of greenhouse emissions by the electric vehicle for the predetermined criterion; (viii) based upon the determined amount of greenhouse emissions by the electric vehicle for the predetermined criterion, determine a sustainability score for the electric vehicle, wherein the sustainability score represents the greenhouse emissions of the electric vehicle in comparison to a gas-powered vehicle for a current lifetime of the electric vehicle; and (ix) cause to display the determined electric vehicle sustainability score. The storage media may include additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A telematics system comprising:
at least one memory; and
at least one processor in communication with the at least one memory, wherein the at least one processor is configured to:
receive information corresponding to a first charging station where an electric vehicle is charged;
generate a first message including the received information corresponding to the first charging station;
transmit the first message to an application server;
receive, from the application server, a second message, the second message including greenhouse emissions information corresponding to a unit of electricity provided by the first charging station for charging the electric vehicle;
determine a total number of units of electricity outputted for charging a battery of the electric vehicle at the first charging station;
determine a number of units of electricity stored in the battery consumed for operating the electric vehicle for a predetermined criterion;
based upon the number of consumed units of electricity and the greenhouse emissions information included in the second message, determine an amount of greenhouse emissions by the electric vehicle for the predetermined criterion;
based upon the determined amount of greenhouse emissions by the electric vehicle for the predetermined criterion, determine a sustainability score for the electric vehicle, wherein the sustainability score represents the greenhouse emissions of the electric vehicle in comparison to a gas-powered vehicle for a current lifetime of the electric vehicle; and
cause display of the sustainability score for the electric vehicle.

2. The telematics system of claim 1, wherein the at least one processor is further configured to receive information corresponding to the first charging station including at least one of an identifier for identifying the first charging station or a location of the first charging station.

3. The telematics system of claim 2, wherein the identifier or the location of the first charging station is received as a user input or via a sensor.

4. The telematics system of claim 3, wherein the location of the first charging station is determined based upon data captured by a global positioning system (GPS) sensor, or wherein the identifier of the first charging station is determined based upon data captured by a camera or a near-field communication (NFC) sensor.

5. The telematics system of claim 1, wherein the at least one processor is further configured to determine the sustainability score for the electric vehicle by determining an amount of greenhouse emissions produced during production of the electric vehicle and an amount of greenhouse emissions produced during production of a similar-sized gas-powered vehicle.

6. The telematics system of claim 1, wherein the electric vehicle sustainability score is a number score or a letter score, and wherein the electric vehicle sustainability score represents a total amount of greenhouse emissions for the current lifetime of the electric vehicle including emissions resulting from production and operation of the electric vehicle as compared to a similar lifetime of a similar-sized gas-powered vehicle.

7. The telematics system of claim 1, wherein the electric vehicle is a partial electric vehicle or a full electric vehicle.

8. The telematics system of claim 1, wherein the electric vehicle is a partial electric vehicle, the at least one processor is further configured to determine the amount of greenhouse emissions by the partial electric vehicle for the predetermined criterion by:
determining an amount of greenhouse emissions from consumption of energy other than electric energy from the battery of the electric vehicle for the predetermining criterion; and
determining the amount of greenhouse emissions by the electric vehicle from consumption of electric energy from the battery of the electric vehicle for the predetermined criterion.

9. The telematics system of claim 1, wherein the predetermined criterion is (i) a predetermined time period, or (ii) a predetermined distance travelled by the electric vehicle.

10. The telematics system of claim 1, wherein the at least one processor is further configured to cause display of (i) a list of one or more charging stations in an area of a preconfigured distance surrounding the electric vehicle and (ii) respective greenhouse emissions information corresponding to a unit of electricity provided by the one or more charging stations of the list.

11. The telematics system of claim 1, wherein the telematics system is integrated into the electric vehicle.

12. A user computing device comprising:
at least one display;
at least one memory; and
at least one processor in communication with the at least one memory, wherein the at least one processor is configured to:
receive information corresponding to a first charging station where an electric vehicle is charged;
generate a first message including the received information corresponding to the first charging station;
transmit the first message to a backend system;
receive, from the backend system, a second message, the second message including greenhouse emissions information corresponding to a unit of electricity provided by the first charging station for charging the electric vehicle;
receive a total number of units of electricity outputted for charging a battery of the electric vehicle at the first charging station;
receive a number of units of electricity stored in the battery consumed for operating the electric vehicle for a predetermined criterion;
based upon the number of consumed units of electricity and the greenhouse emissions information included in the second message, determine an amount of greenhouse emissions by the electric vehicle for the predetermined criterion;
based upon the determined amount of greenhouse emissions by the electric vehicle for the predetermined criterion, determine a sustainability score for the electric vehicle, wherein the sustainability score represents the greenhouse emissions of the electric vehicle in comparison to a gas-powered vehicle for a current lifetime of the electric vehicle; and
cause to be displayed, on the at least one display, the determined electric vehicle sustainability score.

13. The user computing device of claim 12, wherein the at least one processor is further configured to receive the information corresponding to the first charging station by at least one of:
(i) receiving an identifier for identifying the first charging station by receiving a user input or receiving the identifier via a sensor including a camera or a near-field communication (NFC) sensor; or
(ii) receiving a location of the charging station by receiving a user input or receiving sensor data from a global positioning system (GPS) sensor.

14. The user computing device of claim 12, wherein the at least one processor is further configured to determine the sustainability score of the electric vehicle by receiving, from the backend system, an amount of greenhouse emissions generated during production of the electric vehicle and an amount of greenhouse emissions generated during production of a similarly sized gas-powered vehicle.

15. The user computing device of claim 12, wherein the electric vehicle sustainability score is a number score or a letter score, and wherein the electric vehicle sustainability score represents a total amount of greenhouse emissions for the current lifetime of the electric vehicle including emissions resulting from production and operation of the electric vehicle as compared to a similar lifetime of a similarly sized gas-powered vehicle.

16. The user computing device of claim 12, wherein the electric vehicle is a partial electric vehicle or a full electric vehicle.

17. The user computing device of claim 12, wherein the electric vehicle is a partial electric vehicle, and the at least one processor is further configured to determine the amount of greenhouse emissions by the partial electric vehicle for the predetermined criterion further by:
determining an amount of greenhouse emissions from consumption of energy other than electric energy from the battery of the electric vehicle for the predetermining criterion; and
determining the amount of greenhouse emissions by the electric vehicle from consumption of electric energy from the battery of the electric vehicle for the predetermined criterion.

18. The user computing device of claim 12, wherein the predetermined criterion is a predetermined time period, or a predetermined distance travelled by the electric vehicle.

19. The user computing device of claim 12, wherein the at least one processor is further configured to cause display of (i) a list of one or more charging stations in an area of a preconfigured distance surrounding the electric vehicle and (ii) respective greenhouse emissions information corresponding to a unit of electricity provided by the one or more charging stations of the list.

20. A computer-implemented method for determining a sustainability score for an electric vehicle, the computer-implemented method performed by a computing device including at least one processor and at least one memory device, the computer-implemented method comprising:
receiving information corresponding to a charging station where an electric vehicle is charged;
generating a first message including the received information corresponding to the charging station;
transmitting the first message to an application server;
receiving a second message from the application server, the second message including greenhouse emissions information corresponding to a unit of electricity provided by the charging station for charging the electric vehicle;
determining a total number of units of electricity outputted for charging a battery of the electric vehicle at the charging station;
determining a number of units of electricity stored in the battery consumed for operating the electric vehicle for a predetermined criterion;
based upon the number of consumed units of electricity and the greenhouse emissions information included in the second message, determining an amount of greenhouse emissions by the electric vehicle for the predetermined criterion;
based upon the determined amount of greenhouse emissions by the electric vehicle for the predetermined criterion, determining a sustainability score for the electric vehicle, wherein the sustainability score represents the greenhouse emissions of the electric vehicle in comparison to a gas-powered vehicle for a current lifetime of the electric vehicle; and
causing to display the determined electric vehicle sustainability score.
